(19) United States
(12) Patent Application Publication
(10) Pub. No.: US 2001/0038383 A1
(43) Pub. Date: Nov. 8, 2001

(54) Method and apparatus for information management

(76) Inventors: Petter Ericson, Malmo (SE); Ida Westerberg, Malmo (SE)

Correspondence Address: Gerson S. Panitch, Finnegan, Henderson, Farabow,, Garrett & Dunner, L.L.P., 1300 I Street, N.W., Washington, DC, 20005-3315, US

(21) Appl. No.: 09/812,898

(22) Filed: Mar. 21, 2001

Related U.S. Application Data
(60) Provisional application No. 60/210,652, filed on Jun. 9, 2000.

(30) Foreign Application Priority Data
Apr. 5, 2000 (SE) 0001253-4

(51) Int. Cl. G09G 5/00

(52) U.S. Cl. 345/173

(57) ABSTRACT

A label defines a function to be executed with respect to information that is recorded from a writing surface. The label includes a pattern that is associated with the function so that detection of the pattern identifies the function. The label may be configured to be attached to the writing surface by adhesive.

### CROSS REFERENCE TO RELATED APPLICATIONS

This application claims priority benefits based on Swedish Patent Application No. 0001253-4, filed Apr. 5, 2000, and U.S. Provisional Application 60/210,652, filed Jun. 9, 2000, the technical disclosures of both of which are hereby incorporated herein by reference.

### FIELD OF THE INVENTION

The present invention relates to a method and apparatus for managing information, and in particular, for managing information that is recorded with a digital pen.

### BACKGROUND OF THE INVENTION

U.S. Pat. No. 5,852,434, the technical disclosure of which is herein incorporated by reference, discloses a device that allows a user to input handwritten or drawn information into a computer at the same time the information is handwritten or drawn on a writing surface. The device may comprise a writing surface with a position code that codes X & Y coordinates, and a special digital pen with a pen point that the user may use to write or draw on the writing surface. The pen may also have a light source for illuminating the position code, and a CCD sensor for receiving the light that is reflected from the position code. The position information received by the CCD sensor may be sent to a computer for processing.

### SUMMARY OF A FEW ASPECTS OF THE INVENTION

Systems consistent with this invention may include a label for managing information, wherein the label defines a function to be executed with respect to information that is recorded from a writing surface. The label may include a pattern that is associated with the function so that detection of the pattern identifies the function, and wherein the label is configured to be attached to the writing surface.

Methods consistent with this invention manage inforamtion. Such methods may comprise digitally recording information written on a writing surface and attaching a label with a first pattern to the writing surface. The first pattern may define a function to be executed with respect to the digitally recorded information. The function may be executed through detection of the first pattern.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing general description and the following detailed description are exemplary and explanatory and are intended to provide further explanation of the invention as claimed.

### BRIEF DESCRIPTION OF THE DRAWINGS

The present invention is described by means of embodiments with reference to accompany drawings, in which

FIG. 1 shows a first embodiment of a label consistent with the invention;

FIG. 2 shows the location of a first and a second coordinate area of an imaginary surface, consistent with the invention;

FIG. 3 shows a digital pen consistent with the invention;

FIG. 4 shows a writing surface that may be used together with a label, both consistent with the invention;

FIG. 5 is a flow diagram of an example of a method consistent with the invention; and

FIG. 6 shows a second embodiment of a label consistent with the invention.

### DESCRIPTION OF PREFERRED EMBODIMENTS

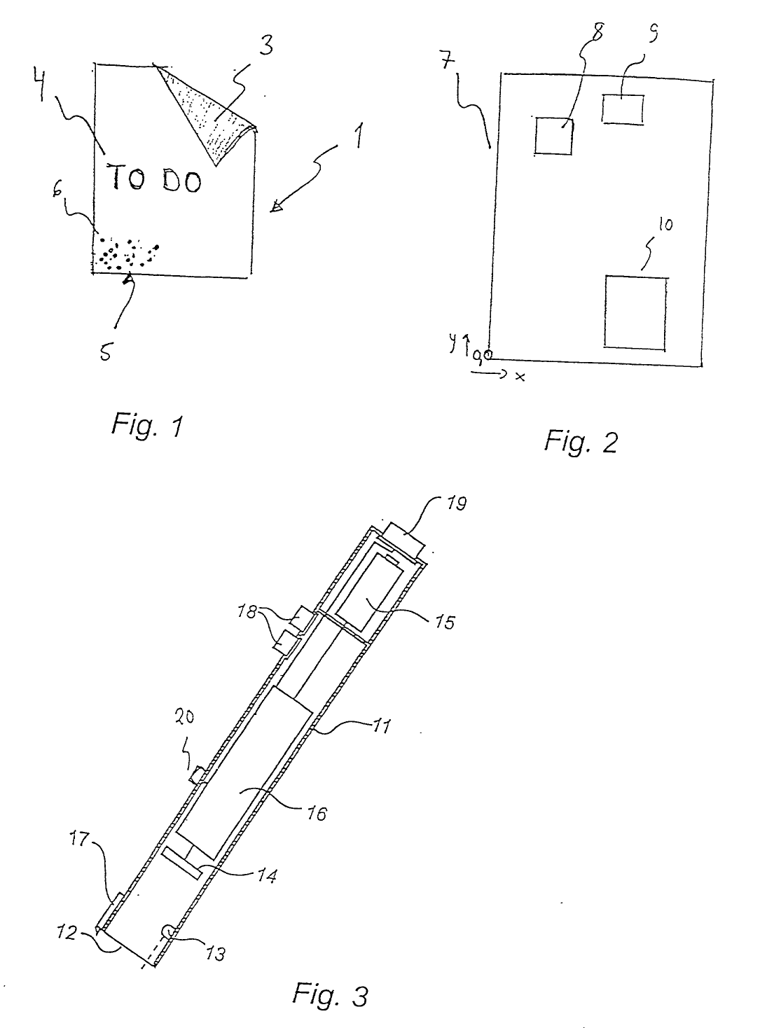

FIG. 1 shows an adhesive label 1 consistent with this invention. Adhesive label 1 may consist of a small piece of paper that may have an adhesive layer 3 on its reverse side. The front of adhesive label 1 may provide a visual indication 4 of the function of adhesive label 1. In this example, the function may be to store a task in a digital task list. The front of label 1 may also have a first absolute-position coding pattern 5 that may include a large number of points 6. In the embodiment shown in FIG. 1, the absolute-position coding pattern may extend over the front of the entire adhesive label 1. For clarity, the coding pattern is shown on the small part of the adhesive label in FIG. 1. Label 1 may be attached to a writing surface and may comprise any means for attaching it thereto.

Each point of the large number of points 6 may code one of four values (00, 01, 10, or 11). The value of the point may be determined by its position in relation to a regular virtual raster, i.e., an imaged raster that may not be visible on label 1. A plurality of points, 5×5 points for example, may code coordinates of a position on an imaginary surface. For example, the first binary bit in the values of the points may together code an X coordinate, and the second binary bit in the values of the points may together code a Y coordinate. Each such area with 5×5 points may code a unique position on the imaginary surface, which means that a digital pen may read an arbitrary area that contains 5×5 points and determine a position. Each point thus may contribute to the coding of the coordinates of a plurality of positions. The points may be so small that they are perceived by the human eye as a gray tone on the adhesive label.

Absolute-position coding pattern 5 on the label 1 may constitute a subset of a larger, virtual absolute-position coding pattern that may code the coordinates for a large number of positions on an imaginary surface. The entire larger virtual absolute-position coding pattern may not be written out somewhere, but it may correspond to the entire unique absolute-position coding pattern that, in principle, may be built by means of the coding. In the same way, the imaginary surface may correspond to all the unique positions that may be coded with the aid of the absolute-position coding pattern.

The absolute-position coding pattern may be of different types. In U.S. Pat. No. 5,852,434, for example, an absolute-position coding pattern is described that codes each position with a unique symbol. Another example of an absolute-position coding pattern of this type is described in the International Patent Application No. WO 01/16691, the technical disclosure of which is hereby incorporated by reference. An alternative absolute-position coding pattern is shown in the International Patent Application No. WO 00/73983, the technical disclosure of which is also hereby incorporated by reference. For example, the absolute-position coding pattern on label 1 may include a plurality of identical markings that are displaced in relation to a regular raster. An advantage of this graphical configuration of the pattern is that the detection of positions may be very reliable.

With regard to label 1 in FIG. 1, it is though a small part of the larger absolute-position coding pattern is cut and placed on the label. This part, or a partial area thereof, may correspond to a coordinate area that is dedicated to the label function. Label 1 may define the function of storing a task in a digital task list. To this end, the absolute-position coding pattern 5 on the adhesive label may code coordinates of positions that lie within a first coordinate area on the imaginary surface. This first coordinate area may be dedicated to the function of storing a task in a digital task list.

Label 1 may define a function that is executed with respect to information that is recorded from a writing surface. Label 1 may also have a pattern that is specific to the function so that detection of the pattern makes it possible to identify the function automatically. The pattern may be any pattern that is suitable for defining a specific function, e.g., a geometric pattern or an image. In one embodiment, the pattern may be an absolute position coding pattern because its use requires less processing capacity. The function may be identified because the coordinate area may be dedicated to only this function.

Labels, such as label 1, may be used for defining different functions that may be executed with respect to recorded information. A label may be provided with a visual indication that specifies the function associated with the label so that the user may see the function associated with the label.

The label may be placed on writing surfaces with the same type of absolute-position coding pattern, and the digital pen may record coordinates both from the writing surface and from the label and may distinguish how the different coordinates should be processed.

FIG. 2 shows an imaginary surface 7 that includes a first coordinate area 8 dedicated to the function of storing a task in a digital task list. Imaginary surface 7 also has a second coordinate area 9 that is dedicated to handwritten notes. The subset of the absolute-position coding pattern that codes coordinates of positions within the second coordinate area may be applied, for example, to a notepaper. It may also have a third coordinate area 10 that is dedicated for example to the function of sending an e-mail.

The function that the label defines may be sending recorded information, such as an e-mail, a fax, or an SMS message, and converting and storing the recorded information in a predetermined application. The application may be, for example, a task list, a calendar, an address book, or a similar application that may store notes of the type that one may write by hand on paper. The conversion of the recorded information may include character recognition, encryption, conversion of drawing format, translation, or the like.

Other coordinate areas on the imaginary surface may be dedicated to other functions that may be defined with the aid of other adhesive labels. Furthermore, the function of a label may be defined by the user. For example, labels may be sold that are marked with numbers, and the user may define the function with the aid of a program in his computer.

FIG. 3 shows a digital pen that may be used for recording information that is written on a writing surface with an absolute-position coding pattern and for reading the absolute-position coding pattern on labels. The digital pen may include a casing 11 with an opening 12 on its short side. In use, the short side may abut against or be held at a small distance from the surface from which the absolute-position coding pattern is read. The casing may include an optical part, an electronic part, and a power supply.

The optical part may include at least one light-emitting diode 13 for illuminating the surface to be imaged. The optical part may also include a light-sensitive area sensor 14, such as a CCD or CMOS sensor for example, for recording a two-dimensional image. The digital pen may also inlcude a lens system. The power supply may be a battery 15 mounted in a separate compartment in the casing.

The electronic part may include a processor 16 that may record an image from the sensor 14, identify points in the image, determine coded coordinates by the points, and store these coordinates in memory. As shown below, processor 16 may manage the stored coordinates in different ways thereafter.

The digital pen may also comprise a pen point 17. Pen point 17 may allow the user to write normal pigment-based writing that, at the same time, is recorded by the digital pen with the aid of the absolute-position coding pattern. Pen point 17 may be retractable and extendable so that the user may control whether to use it or not. As used herein pen point 17 generally refers to any physical marking implement.

The digital pen may also include buttons 18 that may activate and control the pen. The digital pen may also have a transceiver 19 for wireless communication, such as IR or a radio link (e.g., Bluetooth) with external units.

The pen may also comprise means 20 for emitting a signal when the pen detects that it has recorded coordinates that define a function. Means 20 may include, for example, a buzzer that emits a sound signal, or a light-emitting diode that emits a light signal.

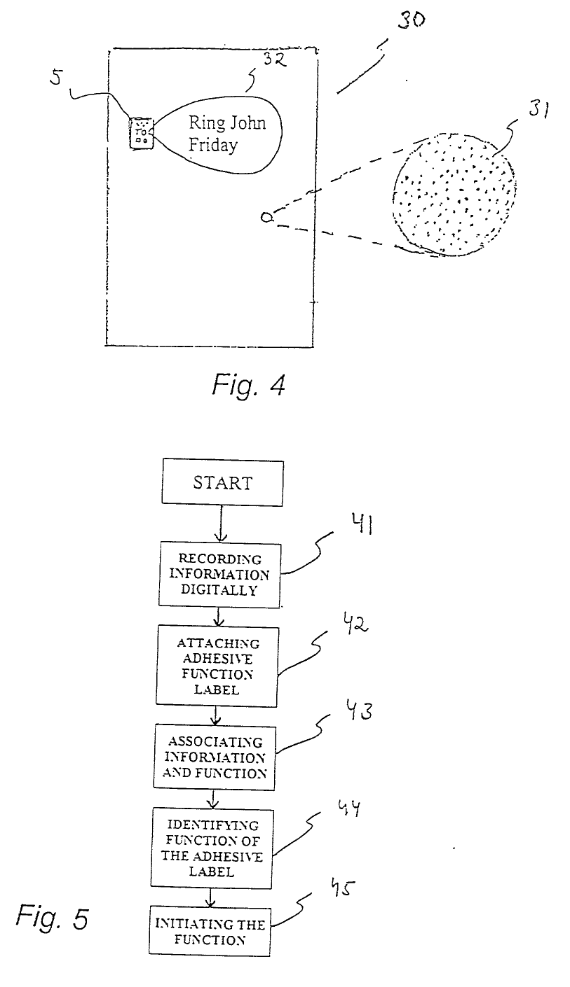

FIGS. 1-5, illustrate how the adhesive label in FIG. 1 may be used. FIG. 4 shows a writing surface that may be used together with a label consistent with this invention. FIG. 5 is a flow diagram of an example of a method consistent with this invention. In FIG. 4, notepaper 30 may have a second absolute-position coding pattern that codes coordinates 31 within the second coordinate area 9 in FIG. 2, which is dedicated to recording handwritten or drawn notes. Suppose a user is talking to John, for example, on the telephone and they agree that the user will ring John on Friday. As shown in FIG. 4, the user makes a note about this on notepaper 30 with his digital pen. The digital pen digitally may record the note by continuously detecting the part of the second absolute-position coding pattern that is located within the field of view of the image sensor 14. The digital pen may then store the detected coordinates in memory (step 41 in FIG. 4).

When the user finishes the telephone conversation it is possible to store the information on notepad 30 in a digital task list in a computer. To do this, the user may stick an adhesive label with the indication “to do” on notepaper 30 (step 42). After that, he may associate the information that to be stored as a task in the digital task list with the function “to do” by placing the digital pen on the adhesive label and drawing a line 32 from it and around the information and back to the adhesive label (step 43). The digital pen may then detect the coordinates that are coded by the first absolute-position coding pattern on the adhesive label. The function of the adhesive label may be identified with the aid of these coordinates (step 44) and the function is initiated (step 45).

As may be seen from the above, label 1 may be used together with a writing surface that includes a pattern, possibly an absolute-position coding pattern that enables handwritten information to be recorded in digital form. In this case, the same digital pen that is used for recording the information from the writing surface may be used for identifying the function that is to be executed with respect to the information because the pen detects an absolute-position coding pattern in both cases. This increases the functionality of digital pens, i.e., a user may avoid first recording information with the aid of the digital pen and then processing the information further in a computer. Instead, the user may execute all operations with the aid of the digital pen, a writing surface, and the label that defines the function that is executed with respect to the recorded information.

The recorded coordinates may then consist of the coordinates that represent the handwritten note, the coordinates from the adhesive label, and the coordinates of line 32. For example, the absolute-position coding pattern on the label may be a first subset of a larger virtual absolute-position coding pattern that codes coordinates for a large number of positions on an imaginary surface, and the absolute-position coding pattern on the label codes coordinates for at least one of the positions that are lying within a first coordinate area that may be dedicated to the function. The first coordinate area may be situated at a distance from a second coordinate area on the imaginary surface that contains positions, the coordinates of which are coded by a second subset of the larger virtual absolute-position coding pattern, the second subset being located on the writing surface. In this way, the label may be distinguished in a simple manner from the writing surface.

Therefore, a method for managing information may include the steps of recording information that is written on a writing surface in digital form, attaching a label with a first pattern to the writing surface, which first pattern defines a predetermined function that is executed with respect to the digitally recorded information, and initiating the execution of the predetermined function through detection of the first pattern.

Alternatively the digital pen itself may contain information about different areas on the imaginary surface, and the digital pen may identify that the adhesive label defines the function of storing a note in a task list. In this case, the digital pen may send the coordinates that represent the “task” together with an indication of the function via transceiver 19 to a computer. The pen may also comprise character recognition software that converts the coordinates into characters so that the task may be sent and stored in character-coded format.

Another alternative is that the user's computer may contain software that carries out the above-mentioned steps, and the processor of the digital pen may send the coordinates that are lying within the first, second, and third coordinate area to the user's computer for further processing.

Another alternative is that part of the processing of the coordinates may be carried out or controlled from a server in a computer network. This server may contain information about different coordinate areas or regions on the imaginary surface 7. The digital pen may send all recorded information to this server, which processes the information, interprets it, and sends the information to a relevant location. According to a further variant, the digital pen may only send a part of the recorded information to the server, which then returns instructions to the digital pen about how it should deal with the information. The digital pen may communicate with the server via a computer, a mobile telephone, or some other unit that allows connection to a computer network such as the Internet.

As may be seen from the above, the recorded coordinates may be processed to a different degree in the pen and in external units with which the pen may communicate.

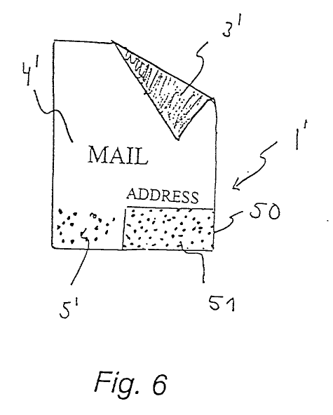

Some of the functions that may be defined with the label imply that information is to be sent to a receiver, the address of which may be specified. The label may contain a writing area for address information. This writing area may have a special absolute-position coding pattern that is dedicated to address information. FIG. 6 shows another embodiment of an adhesive label that defines a function to be executed with respect to information that is recorded from a writing surface to which the adhesive label is attached. This embodiment is especially intended for functions that involve the recorded information being sent to a certain receiver at a particular address.

Like the adhesive label in FIG. 1, the adhesive label 1′ shown in FIG. 6 may comprise a reverse side 3′ with an adhesive layer, a front 4′ with a visual indication of the function indicated by the adhesive label, and a first absolute-position coding pattern 5′ that may code coordinates that define at least one position in a coordinate area dedicated to this function. The adhesive label in FIG. 6 also may comprise writing area 50 that is intended for address information that the user writes by hand. Writing area 50 may either be provided with the same absolute-position coding pattern as the remaining part of adhesive label 1, or with a fourth absolute-position coding pattern 51 that codes coordinates of at least one position within a coordinate area that is dedicated to address information.

The recorded information may be sent to the receiver specified in writing area 50. The address information may be specified in other ways. For example, it may be written in close vicinity to the line 32 in FIG. 4 or in a specified relation to the information. As a further alternative, it may be marked out with a special address symbol.

In a further variant, the user may have personal paper stock such as adhesive labels or business cards, whereby address information is associated with the coordinates or coordinate area(s) that is/are coded by the absolute-position coding pattern on the user's paper stock. He may define that his personal e-mail address should be associated with some of his personal paper stock, after which he may distribute the stock to persons from whom he wishes to receive e-mall.

In the examples above, the user may write a handwritten note. The note may also consist of hand-drawn figures or any other graphical information. In an alternative embodiment, the digital pen may not have an ink-writing pen point because the pen may note information without help of what is written with pigment on a writing surface.

The absolute-position coding pattern may be of another type than the ones described above. An alternative pattern may code a single pair of coordinates for one positon on the imaginary surface when defining the function of the adhesive label. The code may, therefore, be such that the same position is read independently of where on the function-defining surface of the adhesive label the digital pen is placed. Instead of the absolute-position coding pattern, some other detectable pattern that is specific to the function may be used. In principle, there may be any type of pattern, for example, a geometric pattern or an image.

The label according to the invention may not be an adhesive label that is attached to a sheet of paper but may be, for example, a magnetic label that is attached to a magnetic tablet on which the user may write erasable information. The label may be an adhesive label in which the means for attaching the adhesive label to the writing surface comprises a layer of adhesive. The adhesive label may include all types of thin, sheet-shaped labels that have adhesiveness. The adhesive layer may be a layer of glue that permanently attaches the adhesive label to the writing surface. An adhesive label of this type may be provided with a protective paper that is removed during use. As an alternative, the adhesive layer may be of low adhesiveness so that the label may be removed and used again. As a further alternative, the adhesive layer may be of a type that may be activated, for example, by moisture, for adhesion. Other alternatives are also possible.

The adhesive labels may be arranged as an adhesive-label chart that includes a plurality of adhesive labels of the type described above. They may be arranged, for example, in a similar way to a postage stamp chart with separating lines between the adhesive labels or on a common protective sheet from which the adhesive labels are removed one at a time. A plurality of adhesive labels that are associated with different functions may be suitably arranged as one chart so that the user may have access to a complete set of different functions.

The writing surface may be a sheet of paper, a whiteboard, a magnetic tablet, or some other writing surface on which it is possible to write or draw information by hand. The means for attaching label 1 to the writing surface may be any type of means that makes it possible to attach the label temporarily or permanently to the writing surface. They may be, for example, mechanical means that engage the writing surface, magnetic means that attach to the writing surface with the aid of magnetic forces, or adhesive means that cause the label to adhere to the writing surface.

The label may also be used together with an arbitrary writing surface and a digital pen that records handwritten text in another way than by reading a pattern. An example of such a digital pen is a pen that has one or more accelerometers that sense displacement of the pen. In this case, the pen may also be provided with an optical sensor that may record the absolute-position coding pattern on the label. Another example is a digital pen that records handwritten text in the way that is described in the International Patent Application No. WO 99/60467, the technical disclosure of which is hereby incorporated by reference.

Finally, the association of the recorded information with the function may be made in other ways than that shown above. For example, it may be made by using different symbols. In another embodiment, the label is an integral part of the writing surface, and may have no adhesive properties.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. An apparatus comprising:
a label for managing information, wherein the label defines a function to be executed with respect to information that is recorded from a writing surface, wherein the label includes a pattern that is associated to the function so that detection of the pattern identifies the function, and wherein the label is configured to be attached to the writing surface.

2. The apparatus according to claim 1, where the pattern is an absolute-position coding pattern.

3. The apparatus according to claim 2, where the absolute-position coding pattern is a first subset of a large virtual absolute-position coding pattern that codes coordinates for a large number of positions on an imaginary surface, wherein the absolute-position coding pattern codes coordinates for at least one of the positions lying within a first coordinate area dedicated to the function.

4. The apparatus according to claim 3, wherein the first coordinate area is situated a distance from a second coordinate area on the imaginary surface, wherein the second coordinate area contains positions the coordinates of which are coded by a second subset of the large virtual absolute-position coding pattern, wherein the second subset is located on the writing surface.

5. The apparatus according to claim 2, wherein the absolute-position coding pattern on the label comprises a plurality of identical markings displaced in relation to a regular raster.

6. The apparatus according to claim 1, wherein the function is selected from the group of sending the recorded information, converting the recorded information, and storing the recorded information.

7. The apparatus according to claim 1, wherein the label includes a visual indication that specifies the function associated with the label.

8. The apparatus according to claim 1, wherein the label further includes a writing area for address information.

9. The apparatus according to claim 1, wherein the label is an adhesive label, wherein the adhesive label comprises a layer of adhesiveness for attaching the adhesive label to the writing surface.

10. The apparatus according to claim 9, wherein the adhesive label is attached to a chart comprising a plurality of adhesive labels.

11. The apparatus according to claim 1 0, wherein the plurality of adhesive labels define a plurality of differing functions.

12. The apparatus according to claim 1, wherein the label is attached to a writing surface having a second pattern.

13. The apparatus according to claim 12, wherein the second pattern is an absolute-position coding pattern.

14. A method for managing information comprising:
digitally recording information written on a writing surface;
attaching a label with a first pattern to the writing surface, wherein the first pattern defines a function to be executed with respect to the digitally recorded information; and
initiating an execution of the function through detection of the first pattern.

15. The method according to claim 14, wherein the label is an adhesive label.

16. The method according to claim 14, wherein the first pattern is an absolute-coding pattern.

17. The method according to claim 14, wherein the writing surface has a second pattern, and further comprising recording the information by detecting the second pattern.

18. The method according to claim 17, wherein the second pattern is the absolute-position coding pattern.

19. The method according to claim 14, wherein initiating the execution of the function comprises associating the recorded information with the function by drawing a mark formed by a digital pen from the label to a part of the writing surface on which the recorded information is written.

20. The method according to claim 19, further comprising recording an address indication with the aid of the digital pen.

21. An apparatus comprising:
a label for managing information, wherein the label is configured to be attached to a writing surface, wherein the label includes a pattern that is associated to a function to be executed with respect to information recorded from a writing surface, and wherein detection of the pattern identifies the function.

22. The apparatus according to claim 21, where the pattern is an absolute-position coding pattern.

23. The apparatus according to claim 22, where the absolute-position coding pattern defines a first coordinate area associated with the label.

24. The apparatus according to claim 23, wherein a second coordinate area associated with the writing surface is defined by the absolute-position coding pattern.

25. The apparatus according to claim 24, wherein the function is selected from the group of sending the recorded information, converting the recorded information, and storing the recorded information.

26. The apparatus according to claim 21, wherein the label is an adhesive label, and wherein the adhesive label comprises a layer of adhesiveness for attaching the adhesive label to the writing surface.

27. A method for managing information comprising:
digitally recording information written on a writing surface having a first pattern thereon;
associating a function to a second pattern on a label attached to the writing surface; and
initiating an execution of the function with respect to the digitally recorded information by detecting the second pattern.

28. The method according to claim 27, wherein the label is an adhesive label.

29. The method according to claim 27, wherein the first and second pattern is an absolute-coding pattern.

30. The method according to claim 27, wherein initiating the execution of the function includes associating the recorded information with the function by drawing a mark formed by a digital pen from the label to a part of the writing surface.

31. Paper stock for providing functionality to a digital pen, the paper stock comprising:
a code on the paper stock readable by the digital pen;
a visual marking on the paper stock for alerting a user to a function associated with the code, wherein when the digital pen detects the code, the function is enabled.

32. The paper stock of claim 31, wherein the code is configured to enable the function of sending information detected by the digital pen.

33. The paper stock of claim 31, wherein the code is configured to enable the function of storing in a digital calendar information detected by the pen.

34. The paper stock of claim 31, wherein the code is configured to enable the function of storing in a digital task list information detected by the digital pen.

35. The paper stock of claim 31, wherein the code is configured to enable the function of storing in a digital address book information detected by the digital pen.

36. The paper stock of claim 31, wherein the code is configured to enable the function of applying a character recognition algorithm to information detected by the digital pen.
